(19) United States
(12) Patent Application Publication
(10) Pub. No.: US 2007/0222776 A1
(43) Pub. Date: Sep. 27, 2007

(54) Display rotation apparatus

(75) Inventors: Dong-Won Choi, Suwon-si (KR); Chil-Sung Lee, Suwon-si (KR); Kyoung-Shin Park, Suwon-si (KR); Jae-Kyung Kim, Ansan-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/727,384

(22) Filed: Mar. 26, 2007

(30) Foreign Application Priority Data
Mar. 27, 2006 (KR) 10-2006-0027464

(51) Int. Cl. G09G 5/00

(52) U.S. Cl. 345/204

(57) ABSTRACT

The present invention relates to a display rotation apparatus. The present invention provides a display rotation apparatus, including a support, a universal joint coupled to the support, a movable body coupled to the universal joint, a driving part coupled to the movable body for rotating the movable body about the universal joint.

### CROSS-REFERENCE TO RELATED APPLICATIONS

This application claims the benefit of Korean Patent Application No. 10-2006-0027464 filed with the Korean Intellectual Property Office on Mar. 27, 2006, the disclosure of which is incorporated herein by reference in its entirety.

### BACKGROUND

1. Technical Field

The present invention relates to a display rotation apparatus.

2. Description of the Related Art

The flat panel display, such as an LCD, PDP, or LED, applied to a TV set or monitor has the advantage of efficiently using a narrow space and is thus replacing the Braun tube TV or monitor, with demands for the flat panel display expected to continually increase in the future. In particular, the flat type LCD or the PDP-applied TV are referred to as a ‘wall mounted type TV’, and are used fixedly adhered to the wall. When viewing the wall mounted type TV adhered to the wall in this way, the screen is seen the widest when the TV is located in front of the viewers.

However, when the TV is fixed, a clear view of the TV may not be obtained when a viewer moves to a different position. The conventional wall-mounted-type TV has difficulty in changing directions, because it has little or only a narrow distance from the wall. Even if another material is applied to distance the TV from the wall, it still will not solve the problem of being unable to rotate to a certain orientation. Moreover, using another apparatus for maintaining a distance between the wall and the TV eliminates the advantage of small volume.

### SUMMARY

An aspect of the present invention is to provide a display rotation apparatus protruding from the wall that is capable of automatic and manual rotation.

One aspect of the present invention provides a display rotation apparatus, including a support, a universal joint coupled to the support, a movable body coupled to the universal joint, a driving part coupled to the movable body for rotating the movable body about the universal joint.

The driving part may include a tension member coupled to two points facing each other about the universal joint, a roller member for guiding the route of the tension member, and a first motor part positioned on the route of the tension member for supplying a tensile force to the tension member. The display rotation apparatus may further include a tension controlling device on the route of the tension member. The display rotation apparatus may further include an elastic body having one end coupled to the movable body, where the elastic body may supply an elastic force opposite the gravitational moment of the display to the movable body.

The first motor part may include a motor and a slip pulley coupled to a driving shaft of the motor, where the tension member may be coupled to the slip pulley.

The support may include a couple portion coupled with the universal joint, a link portion having one end coupled to the couple portion, a second motor part coupled to the joining point of the link portion, and a fixed body coupled with the other end of the link portion, where the couple portion may be extendable from the fixed body while driving the link portion.

The link portion may include, a first hinge member and a second hinge member respectively coupled with the fixed body, a first link element having one end rotatably coupled with the first hinge member, a second link element having one end rotatably coupled with the second hinge member, a third link element having one end rotatably coupled with the first link element by way of an interposed third hinge member, a fourth link element having one end rotatably coupled with the second link element by way of an interposed fourth hinge member, and a fifth hinge member and a sixth hinge member respectively coupled with the couple portion, where the other end of the third link element may be rotatably coupled with the fifth hinge member, and the other end of the fourth link element may be rotatably coupled with the sixth hinge member.

The display rotation apparatus may further include a first gear coupled with the perimeter of the first hinge member, a second gear coupled with the perimeter of the second hinge member and gear-joined with the first gear.

The display rotation apparatus may further include a first gear coupled with the perimeter of the fifth hinge member, and a second gear coupled with the perimeter of the sixth hinge member and gear-joined with the first gear.

The second motor part may be coupled with any one or more of the first hinge member through the sixth hinge member.

The first gear and the second gear may be coupled by an even number of idle gears.

The first motor part and the second motor part may respectively include a motor and a rotary part, where the rotary part may include a clutch unit coupled with a driving shaft, and a driven shaft in contact with the clutch unit, with the driving force of the motor smaller than the frictional force between the driven shaft and the clutch unit.

The frictional force between the driven shaft and the clutch unit may be smaller than the cogging torque of the motor.

The display rotation apparatus may further include one or more washers interposed between the clutch unit and driven shaft.

Additional aspects and advantages of the present invention will become apparent and more readily appreciated from the following description, including the appended drawings and claims, or may be learned by practice of the invention.

### BRIEF DESCRIPTION OF THE DRAWINGS

FIG. 1 is a side view of a display rotation apparatus according to a first disclosed embodiment of the invention.

FIG. 2 is a perspective view of a first motor part according to a second disclosed embodiment of the invention.

FIG. 3 is a cross-sectional view of a rotary part of the first motor part according to the second disclosed embodiment of the invention.

FIG. 4 is a plane view of a support according to a third disclosed embodiment of the invention.

FIG. 5a is a side view of the display rotation apparatus according to a fourth disclosed embodiment of the invention.

FIG. 5b is a plane view of the display rotation apparatus according to the fourth disclosed embodiment of the invention.

### DETAILED DESCRIPTION

The display rotation apparatus according to certain embodiments of the invention will be described below in more detail with reference to the accompanying drawings. In the description with reference to the accompanying drawings, those components are rendered the same reference number that are the same or are in correspondence, regardless of the figure number, and redundant explanations are omitted.

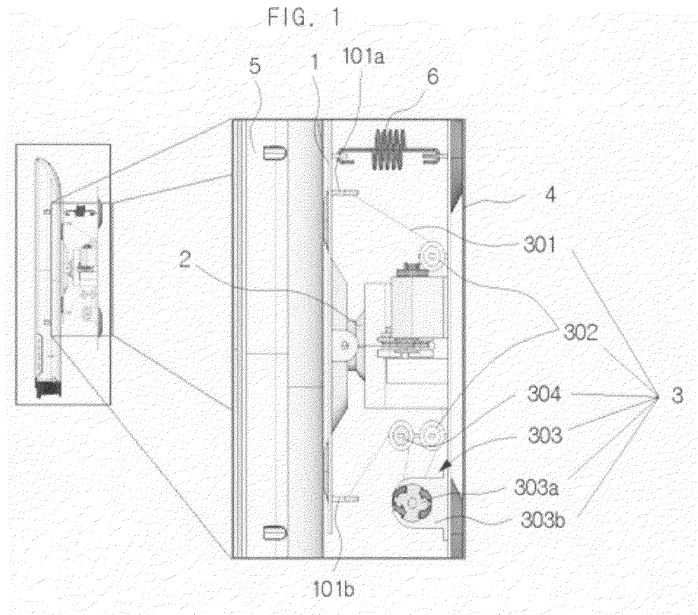

FIG. 1 is a side view of a display rotation apparatus according to a first disclosed embodiment of the invention. Referring to FIG. 1, a movable body 1, connecting parts 101a, 101b, a universal joint 2, a driving part 3, a tension member 301, roller members 302, a first motor part 303, a motor 303b, a slip pulley 303a, a tension controlling device 304, a support 4, a display 5, and an elastic body 6 are illustrated.

The movable body 1 may be coupled with the display 5 as one body. The movable body 1 is coupled with the support 4 by way of the universal joint 2. The Movable body 1 includes the connecting parts 101a, 101b coupled with tension member 301. The connecting members (101a, 101b) may be attached to the movable body 1 symmetrically around the universal joint 2 for smooth up-down moving of the display 5. A pair of connecting members (not illustrated) may also be formed symmetrically on the movable body around the universal joint 2 for right-left rotating.

The elastic body 6 is coupled with the movable body 1 and the support 4 in correspondence with the gravitational moment of the display 5. The weight of the flat type TV is about several 10 kg. Therefore, the display 5 droops down around the universal joint 2 as shown in FIG. 1 if the elastic body 6 is not coupled between movable body 1 and support 4, and the moment thus created subjects the tension member 301 to high tension. When the display 5 is moved in this situation, the motor would be overloaded due to the tension on the tension member 301. As shown in FIG. 1, a coil spring may be used as the elastic body 6, or any of various other springs may be used. The elastic body 6 may be joined to any part of the support 4 or the movable body 1 for preventing the drooping of the display 5 due to the moment.

The driving part 3 is composed of the tension member 301, roller members 302, first motor part 303, motor 303b, slip pulley 303a, and tension controlling device 304.

The tension member 301 may be made of a wire, belt, or chain etc. In this embodiment, a wire is used. As shown in the figure, the tension member 301 is coupled with the connecting parts 101a, 101b. The tension member 301 is coupled with the roller members 302 for guiding the route and with the first motor part 303 for supplying power to the tension member 301. In the embodiment of FIG. 1, two roller members 302 are used, but the number of roller members 302 may vary according to the situation.

The first motor part 303 is composed of a slip pulley 303a and a motor 303b, and the tension member 303 is coupled with the slip pulley 303a. In FIG. 1, since the tension member 301 is a wire, a slip pulley 303a is joined. However, in the case where the tension member 301 is a chain, a corresponding sprocket may be used. Meanwhile, although the first motor part 303 may be coupled with the support 4 as shown in FIG. 1, the first motor part 303 may also be joined with the movable body 1.

The slip pulley 303a transfers the dynamic force of the motor 303b to the tension member 301, such that finally the display is rotated up-down and right-left. Therefore, the frictional force between the slip pulley 303a and the tension member 301 is great enough to move the display 5. That is, slipping may not occur between the slip pulley 303a and the tension member 301 when the motor 303b rotates. However, slipping may occur when forcefully moving the tension member 301, so that the motor 303b is not damaged by the forced rotating. That is, the frictional force between tension member 301 and the slip pulley 303a is smaller than the cogging torque of the motor 303b.

The tension controlling device 304 is positioned on the route of tension member 301 and is coupled with the tension member 301. The tension controlling device 304 is a kind of pulley. The tension controlling device 304 is made to have a varying location in order to control the tension. As the form and configuration of this tension controlling device 304 is obvious to the person skilled in the art, detailed description on this matter is omitted. The binding position of the tension controlling device 304 in the embodiment of FIG. 1 is the support 4, but it may also be coupled with the movable body 1.

Using the slip pulley 303a is a mode that may be used when the tension member 301 is a wire or a belt. Because the slip pulley 303a and tension member 301 would not allow slipping in the case where the tension member 301 is a chain, another mode would be applied. The descriptions below will concern the case where the slip pulley 303a is replaced with a sprocket.

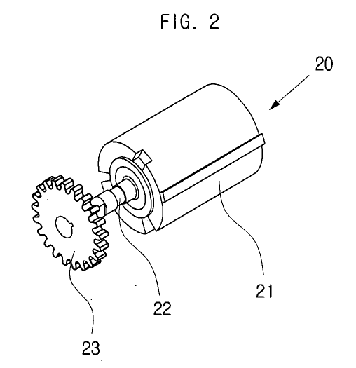

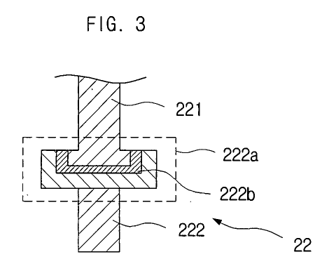

FIG. 2 is a perspective view of a first motor part according to a second disclosed embodiment of the invention, and FIG. 3 is a cross-sectional view of a rotary part of the first motor part according to the second disclosed embodiment of the invention. Referring to FIGS. 2 and 3, a first motor part 20, fixing part 21, rotary part 22, sprocket 23, clutch unit 222a, driving shaft 222, and driven shaft 221 are illustrated.

A motor transfers power to the driving shaft 222 in FIG. 3. The driving shaft 222 is coupled with the driven shaft 221 by the clutch unit 221a. As shown in FIG. 3, the clutch unit 222a controlling the frictional force is coupled with the driving shaft 222 as one body. Moreover, the clutch unit 222a may be coupled with the driven shaft 221. A washer 222b is interposed between the clutch unit 222a and the driven shaft 62 to maintain a constant friction.

The method of operating the rotary part 22 will now be illustrated. When the driving shaft 222 is rotating, the driving force of the motor is smaller than the frictional force of clutch unit 222a. Thus, slipping does not occur between the clutch unit 222a and the driven shaft 221. However, in the case of forcefully rotating the driven shaft 221, slipping occurs because the frictional force of the clutch unit 222a is smaller than the cogging torque of the motor. Consequently, damage of the motor by the external force is prevented. A washer 222b may be interposed between the clutch unit 222a and the driven shaft 221 in order to control this frictional force.

The support 4 of FIG. 1 may be coupled with the wall or a fixed object, or the support 4 may be coupled with the link portions capable of moving the display 5.

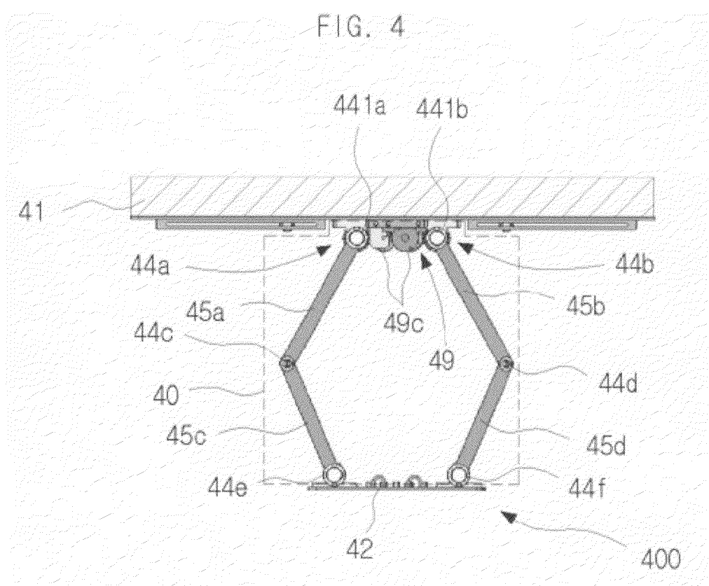

FIG. 4 is a plane view of a support according to a third disclosed embodiment of the invention. Referring to FIG. 4, a link portion 40, a fixed body 41, a couple portion 42, a first hinge member 44a, a second hinge member 44b, a third hinge member 44c, a fourth hinge member 44d, a fifth hinge member 44e, a sixth hinge member 44f, a first link element 45a, a second link element 45b, a third link element 45c, a fourth link element 45d, a second motor part 49, idle gears 49c, and a support 400 are illustrated.

The support 400 is composed of two pairs of link members. The first link element 45a and second link element 45b are respectively coupled with the first hinge member 44a and second hinge member 44b. Therefore, the link elements 45a, 45b may rotate around the central axes of the hinge members 44a, 44b. The fixed body 41 may be the wall, but when a medium is used in-between, such a medium is also included in the fixed body 41. Moreover, the hinge members 44c-44f are respectively interposed between the link elements 45a, 45b and the link elements 45c, 45d, or between the link elements 45c, 45d and the couple portion 42 Although the second motor part 49 may be joined with the hinge members 44a-44f, in this embodiment idle gears 49c are joined with the first gear 441a and second gear 441b, and the second motor part 49 is joined with an even number of idle gears 49c. An even number of idle gears 49c allow the first gear 441a and second gear 441b to rotate in opposite directions. The first and second link elements 45a, 45b operate with the same power in order not to overload one link element.

In the present embodiment, the first gear 441a and second gear 441b are respectively coupled with the first hinge member 44a and second hinge member 44b, and the idle gears 49c and the second motor part 49 are coupled between the first hinge member 44a and the second hinge member 44b. The idle gears 49c and the second motor part 49 may be coupled between the fifth hinge member 44e and the sixth hinge member 44f. Moreover, the first gear 441a and second gear 441b may be directly coupled together without idle gear 49c.

Meanwhile, the support 400 consisting of these link elements may be moved manually, and thus the structure of the rotary part may be implemented as the structure of FIG. 3 in order to prevent damage on the motor of the second motor part 49.

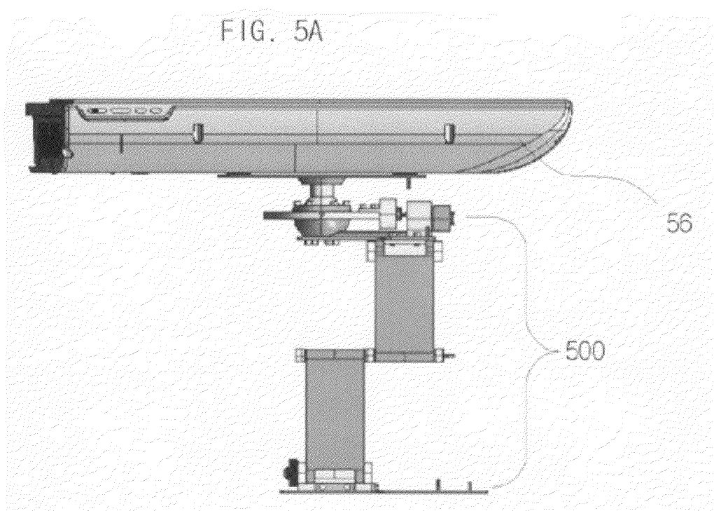

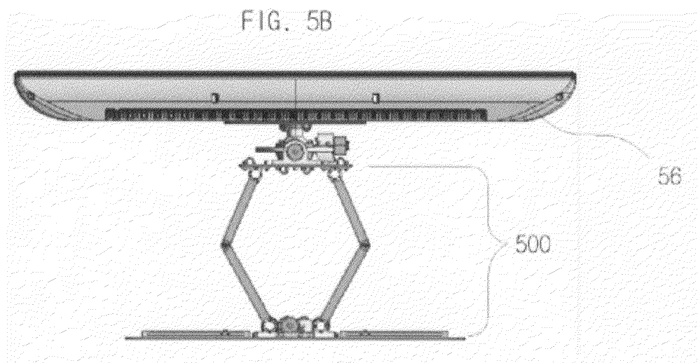

FIG. 5a is a side view of the display rotation apparatus according to a fourth disclosed embodiment of the invention, and FIG. 5b is a plane view of the display rotation apparatus according to the fourth disclosed embodiment of the invention. Referring to FIGS. 5a and 5b, a display 56 and a support 500 are illustrated.

In this embodiment, the movable body of FIG. 1, the universal joint, and the driving part are coupled with the support 400 of FIG. 4. Normally, the link elements of the support 500 are contracted, so that the display 56 adheres closely to the wall. When the orientation of the display 56 is to be changed by means of a remote controller etc., the link elements of the support 500 are extended, and the driving part of FIG. 1 is also controlled.

According to certain aspects of the present invention as set forth above, the display can be automatically rotated in up-down and left-right directions. In addition, no damage is incurred on the motor even in the case of manual rotating. Moreover, by including the link elements in this display rotation apparatus, the display can be rotated in even greater angles.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A display rotation apparatus comprising:
a support;
a universal joint coupled to the support;
a movable body coupled to the universal joint;
a driving part, coupled to the movable body, for rotating the movable body about the universal joint.

2. A display rotation apparatus of claim 1, wherein the driving part comprises:
a tension member coupled to two points facing each other about the universal joint;
a roller member for guiding the route of the tension member; and
a first motor part, positioned on the route of the tension member, for supplying a tensile force to the tension member.

3. The display rotation apparatus of claim 2, wherein the display rotation apparatus further comprises a tension controlling device on the route of the tension member.

4. The display rotation apparatus of claim 3, wherein the display rotation apparatus further comprises an elastic body having one end coupled to the movable body, and the elastic body supplies an elastic force, opposite the gravitational moment of the display, to the movable body.

5. The display rotation apparatus of claim 3, wherein the first motor part comprises:
a motor; and
a slip pulley coupled to a driving shaft of the motor,
and wherein the tension member is coupled to the slip pulley.

6. The display rotation apparatus of claim 3, wherein the support comprises:
a couple portion coupled with the universal joint;
a link portion having one end coupled to the couple portion;
a second motor part coupled to the joining point of the link portion; and
a fixed body coupled with the other end of the link portion,
and wherein the couple portion is extendable from the fixed body according to the driving of the link portion.

7. The display rotation apparatus of claim 6, wherein the link portion comprises:
a first hinge member and a second hinge member respectively coupled with the fixed body;
a first link element having one end rotatably coupled with the first hinge member;
a second link element having one end rotatably coupled with the second hinge member;
a third link element having one end rotatably coupled with the first link element by way of an interposed third hinge member;
a fourth link element having one end rotatably coupled with the second link element by way of an interposed fourth hinge member; and
a fifth hinge member and a sixth hinge member respectively coupled with the couple portion,
and wherein the other end of the third link element is rotatably coupled with the fifth hinge member, and the other end of the fourth link element is rotatably coupled with the sixth hinge member.

8. The display rotation apparatus of claim 7, wherein the display rotation apparatus further comprises:
a first gear coupled with the perimeter of the first hinge member; and
a second gear coupled with the perimeter of the second hinge member and gear-joined with the first gear.

9. The display rotation apparatus of claim 7, wherein the display rotation apparatus further comprising:
a first gear coupled with the perimeter of the fifth hinge member;
a second gear coupled with the perimeter of the sixth hinge member and gear-joined with the first gear.

10. The display rotation apparatus of claim 9, wherein the second motor part is coupled with any one or more of the first hinge member through the sixth hinge member.

11. The display rotation apparatus of claim 9, wherein the first gear and the second gear are coupled by an even number of idle gears.

12. The display rotation apparatus of claim 6, wherein the first motor part and the second motor part respectively comprises:
a motor; and
a rotary part,
the rotary part comprising:
a clutch unit coupled with a driving shaft; and
a driven shaft in contact with the clutch unit;
and wherein the driving force of the motor is smaller than the frictional force between the driven shaft and the clutch unit.

13. The display rotation apparatus of claim 12, wherein the frictional force between the driven shaft and the clutch unit is smaller than the cogging torque of the motor.

14. The display rotation apparatus of claim 13, wherein the display rotation apparatus further comprises one or more washers interposed between the clutch unit and the driven shaft.
